(19) United States
(12) Patent Application Publication
(10) Pub. No.: US 2012/0083386 A1
(43) Pub. Date: Apr. 5, 2012

(54) DRIVE ARRANGEMENT FOR A HYBRID VEHICLE AND METHOD FOR OPERATING AN ELECTRIC ENGINE IN A HYBRID VEHICLE

(75) Inventors: HENNING VOGT, WOLFSBURG (DE); HOLGER LANGE, BRAUNSCHWEIG (DE); GEORG-FRIEDRICH LÜHRS, KASSEL (DE); SASCHA LAUTERBACH, FRITZLAR (DE); HARALD DECKER, GUXHAGEN (DE)

(73) Assignee: VOLKSWAGEN AKTIENGESELLSCHAFT, WOLFSBURG (DE)

(21) Appl. No.: 13/250,022

(22) Filed: Sep. 30, 2011

(30) Foreign Application Priority Data
Sep. 30, 2010 (DE) 10 2010 047 187.9

(51) Int. Cl. B60W 20/00; F16D 13/58; F16F 15/30

(52) U.S. Cl. 477/5; 192/30 V; 903/930; 180/65.285

(57) ABSTRACT

A hybrid vehicle has an internal combustion engine and an electric engine. A drive arrangement for the vehicle has a crankshaft-side clutch part rigidly connected to a crankshaft of the internal combustion engine, and the crankshaft-side clutch part may be coupled to a drive train shaft-side clutch part via a clutch. The clutch part on the drive train shaft side is mechanically connected to a drive train shaft via at least one element for torsional vibration isolation. The drive train shaft is configured at least partially as a rotor of the electric engine. The crankshaft-side clutch part, the clutch and the drive train shaft-side clutch part form at least one part of the primary mass of a dual-mass flywheel. The drive train shaft forms at least one part of the secondary mass of the dual-mass flywheel.

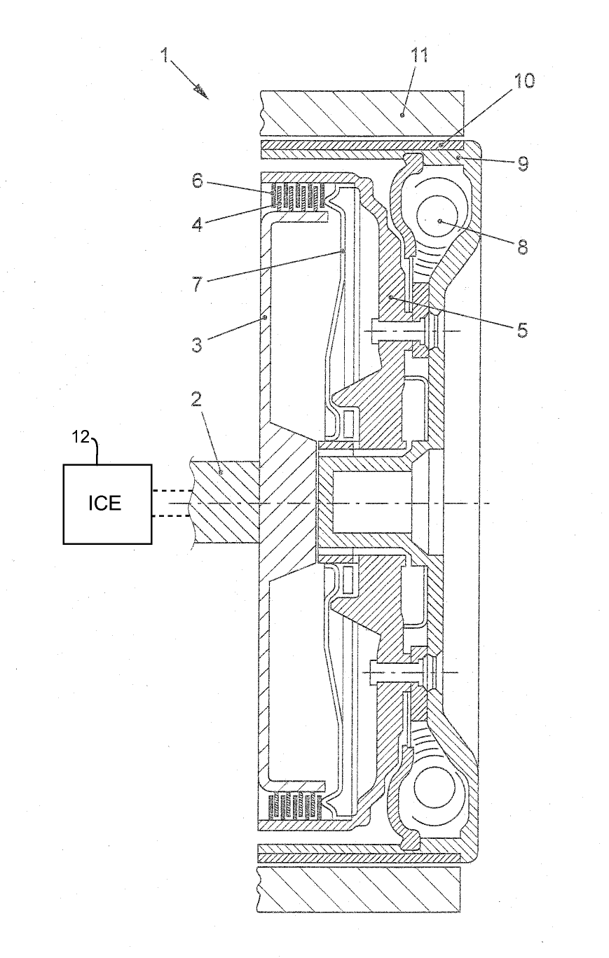

### CROSS-REFERENCE TO RELATED APPLICATION

This application claims the priority, under 35 U.S.C. §119, of German patent application DE 10 2010 047 187.9, filed Sep. 30, 2010; the prior application is herewith incorporated by reference in its entirety.

### BACKGROUND OF THE INVENTION

### Field of the Invention

The invention relates to a drive arrangement for a hybrid vehicle as well as a method for operating an electric engine in a hybrid vehicle.

In prior art hybrid vehicles, drive power may be produced by two elements arranged in the hybrid vehicle for outputting mechanical drive power. In this case, it is known that drive power may be produced both by an internal combustion engine and by an electric engine. In so-called parallel hybrid drives, the mechanical drive power (in particular the torque) produced in each case by the internal combustion engine and the electric engine may be transmitted together to a drive train of the hybrid vehicle. Different scenarios may be conceived for driving the hybrid vehicle. Thus the hybrid vehicle may be driven, for example, solely by the internal combustion engine, solely by the electric engine or by the two engines together. To this end, it is necessary to couple the internal combustion engine and the electric engine in a suitable manner so that a parallel drive of the hybrid vehicle is possible.

It is further known that, when a motor vehicle is driven by an internal combustion engine, speed fluctuations of the internal combustion engine may cause undesirable torsional vibrations in the drive train. In order to achieve the best possible isolation of a gearbox of a motor vehicle relative to the speed fluctuations of the internal combustion engine, it is known to arrange a so-called dual-mass flywheel in the drive train of the motor vehicle. For example, German published patent application DE 10 2008 038 150 A1 discloses a dual-mass flywheel for a drive train of a motor vehicle which comprises a primary flywheel mass and a secondary flywheel mass, and which in each case are arranged rotatably about a common rotational axis and are coupled together in a torsionally flexible manner. Furthermore, the dual-mass flywheel comprises an attenuator unit which dissipatively attenuates a torsional movement between the flywheel masses.

As hybrid vehicles may also comprise an internal combustion engine, it is also desirable to isolate as far as possible speed fluctuations of the internal combustion engine from a gear shaft or gear input shaft. In a hybrid vehicle there is also the possibility of arranging in the drive train a dual-mass flywheel designed as a separate component. In this case, a crank shaft of the internal combustion engine may be connected to the dual-mass flywheel. An output shaft of the dual-mass flywheel may then be mechanically connected to a clutch unit for coupling the internal combustion engine to the electric engine. An output shaft of this clutch may then serve, for example, as a gear input shaft.

German published patent application DE 10 2007 051 991 A1 describes a hybrid vehicle comprising an internal combustion engine, a gearbox and a separating clutch which is arranged between the internal combustion engine and the gear input of the gearbox. The publication further discloses an electric engine which is coupled and/or is able to be coupled to the gear input of the gearbox. Furthermore, the publication discloses a starter clutch which is arranged between the internal combustion engine and the gear input of one of two transmission branches or of two transmission branches. In this case, the publication discloses that a crankshaft of the internal combustion engine may be connected via a separating clutch and a torsional vibration damper, which may be a so-called dual-mass flywheel, to a gear input of a double clutch transmission. Here, the separating clutch and the dual-mass flywheel are configured as separate components.

In this case, there is the problem, inter alia, that there is a high space requirement, in particular in the axial direction, with a separate configuration of the separating clutch and dual-mass flywheel. This is problematic, in particular, in a so-called front-transverse arrangement of the internal combustion engine.

It is further known to configure a gear shaft and/or a gear input shaft of a hybrid vehicle at least partially as a rotor of an electric engine. To this end, U.S. Pat. No. 5,755,302 and its counterpart German published patent application DE 43 23 601 A1 describe a drive arrangement for a hybrid vehicle provided with an internal combustion engine and an electric engine, which at least during time periods may be optionally operated purely by the internal combustion engine drive, purely by the electromotive drive or simultaneously by the combustion drive and electromotive drive. In this case, the internal combustion engine and the electric engine act on a common output shaft leading to a gearbox and the torque transmission is able to be switched in terms of clutch technology between the crankshaft of the internal combustion engine and the output shaft. Furthermore, the electric engine is configured as an external rotor machine. The stator of the electric engine is fastened to the combustion engine or the associated gearbox. The rotor of the electric engine is permanently connected fixedly in terms of rotation to the output shaft and only one clutch is provided as a shifting clutch and separating clutch within the drive arrangement.

### SUMMARY OF THE INVENTION

It is accordingly an object of the invention to provide a drive assembly and a method for operating an electric engine in a hybrid vehicle which overcome the above-mentioned disadvantages of the heretofore-known devices and methods of this general type and which ensure improved reduction in vibration, in particular improved vibration isolation and vibration damping of torsional vibrations of a gear shaft caused by speed fluctuations of the internal combustion engine, wherein the drive assembly has a smaller spatial requirement, in particular in the axial direction.

With the foregoing and other objects in view there is provided, in accordance with the invention, a drive arrangement for a hybrid vehicle having an internal combustion engine and an electric engine, comprising:

at least one crankshaft-side clutch part rigidly connected to a crankshaft of the internal combustion engine;

a drive train shaft configured at least partially as a rotor of the electric engine;

a drive train-side clutch part and a clutch for coupling the drive train-side clutch part to the crankshaft-side clutch part;

the drive train-side clutch part being mechanically connected to the drive train shaft via at least one element for torsional vibration isolation;

the crankshaft-side clutch part, the clutch, and the drive train-side clutch part forming at least one part of a primary mass of a dual-mass flywheel, and the drive train shaft forming at least one part of a secondary mass of the dual-mass flywheel; and

wherein one or more of the primary mass, the secondary mass, or properties of the element for torsional vibration isolation are configured to render a resonant frequency of the dual-mass flywheel to lie below a predetermined rotational frequency of the internal combustion engine.

In other words, the objects of the invention are achieved with a drive arrangement for a hybrid vehicle that has at least one internal combustion engine and at least one electric engine. The electric engine in this case may be configured, for example, as a synchronous machine or asynchronous machine. By means of the electric engine, a torque may be produced from electrical energy which is stored, for example, in a so-called traction battery. By means of the electric engine in generator mode electrical energy may be also produced from kinetic energy of the motor vehicle and, for example, stored (recovered) in the traction battery.

Furthermore, in the drive arrangement at least one clutch part on the crankshaft side is rigidly connected to a crankshaft of the internal combustion engine. The clutch part on the crankshaft side may be designed, for example, as a flywheel and pressure plate of a so-called open friction clutch. In this case, the flywheel and a pressure plate are connected to the crankshaft and a clutch plate is connected to the drive train shaft. For the transmission of force when the clutch is closed, springs, frequently central plate springs, clamp the clutch plate between the pressure plate and the flywheel. For the opening, for example for a shifting process, a mechanically or hydraulically actuated clutch release bearing releases the pressure plate from the spring.

According to the invention, the operating principle of the mechanical force transmission of the clutch may, however, be of any kind. It is primarily important only that the clutch part on the crankshaft side is able to be coupled to the clutch part on the drive train shaft side.

Furthermore, the clutch part on the drive train shaft side is mechanically connected to a drive train shaft via at least one element for torsional vibration isolation. Thus, the clutch part on the drive train shaft side is partly rotatable on the drive train shaft. The clutch part on the drive train shaft side is thus not rigidly but torsionally flexibly connected to the drive train shaft, wherein in the torsional flexible connection the relative angular position may be altered between the clutch part on the drive train shaft side and the drive train shaft. Preferably, the clutch part on the drive train shaft is connected mechanically to the drive train shaft via the at least one element for torsional vibration isolation in an undamped manner.

The drive train shaft in this case may be a gear input shaft, by means of which a torque may be transmitted to a downstream gearbox.

The drive train shaft is configured at least partially as a rotor of the electric engine. The rotor of the electric engine thus has to rotate continuously with the drive train shaft and the rotor is thus not able to be uncoupled from the rotational movement of the drive train shaft.

According to an embodiment of the invention, the clutch part on the crankshaft side, the clutch and the clutch part on the drive train shaft side form at least one part of a primary mass of a dual-mass flywheel. Furthermore, at least one part of the drive train shaft, i.e. also of the rotor of the electric engine, forms a secondary mass of the dual-mass flywheel. The primary mass and the secondary mass are in this case mechanically connected together via the element for torsional vibration isolation in a torsionally flexible and preferably undamped manner. The primary mass and/or secondary mass and/or the properties of the element for torsional vibration isolation, for example a spring constant, are selected so that a resonant frequency of the dual-mass flywheel is lower than a predetermined rotational frequency of the internal combustion engine. For example, the resonant frequency may be lower than the rotational frequency of the internal combustion engine which is dependent on an idling speed. Nevertheless, the predetermined frequency may also be higher than the rotational frequency which is dependent on an idling speed of the internal combustion engine and lower than a rotational frequency which is dependent on a so-called clutch speed. The clutch speed in this case denotes a speed of the drive train shaft, where the internal combustion engine is coupled into the drive train by the clutch. In this case, it is naturally assumed that depending on a shift position of the gearbox, the hybrid vehicle is only able to be driven at low speeds by the electric engine. If, for example, the idling speed of the internal combustion engine is 2000 rpm (revolutions per min), it may be provided firstly to couple the internal combustion engine into the drive train when said internal combustion engine is operated at a speed of, for example, 3000 rpm. In this case it is assumed that when the internal combustion engine is not coupled-in, vibration isolation from speed fluctuations of the internal combustion engine is not necessary.

The arrangement of the primary mass, secondary mass and/or the element for torsional vibration isolation naturally also takes into account the mass of the crankshaft and further mechanical components of the drive train which affect torsional vibrations caused by speed fluctuations.

In this case, the element according to the invention for torsional vibration isolation, in particular, may have a predetermined torsional rigidity, preferably a “flexible” torsional rigidity.

The boundary condition in the design of dual-mass flywheels in this case is that a maximum average moment of the internal combustion engine has to be transmitted. Based on this value and safety margins, a spring stiffness of the element for torsional vibration isolation is determined which ensures the transmission of a torque which has been determined, before the element for torsional vibration isolation, for example, reaches a limit angle of rotation. Thus with internal combustion engines with powerful torque, even greater spring stiffness is required.

On the other hand, the vibration isolation is all the greater, the more flexible the torsionally flexible connection of the primary and secondary flywheel mass. This may require large angles of torsion and leads to the requirement of a maximum angle of torsion which is as large as possible (for example 70 degrees). Thus when selecting the spring stiffness, a compromise has to be made between properties of vibration isolation and torque transmission.

The element according to the invention for torsional vibration isolation may have a simple, for example at least partially linear, connection between the angle of torsion and the transmitted torque, in particular a single-stage characteristic curve.

Furthermore, the element according to the invention for torsional vibration isolation may have no damping properties or only damping properties, whereby the element for torsional vibration isolation is used exclusively for vibration isolation and not for vibration damping, i.e. a conversion of vibrational energy into heat and the resulting reduction of the vibration amplitude at and/or close to the resonant frequency. To this end, a damping factor of the element for torsional vibration isolation can be 0 or a predetermined (low) value.

In this case, care has to be taken that the torsional stiffness of elements for torsional vibration isolation of dual-mass flywheels is lower, in particular up to three times lower, than the torsional stiffness of elements integrated in clutches for torsional damping, such as for example the element shown in the above-mentioned U.S. Pat. No. 5,755,302 and German patent application DE 43 23 601 A1 for torsional damping. As a result, an angle of torsion of a dual-mass flywheel with the same moments is (substantially) larger than an angle of torsion in conventional torsional dampers. Also, elements integrated in clutches for torsional damping generally have a high degree of damping.

The drive arrangement according to the invention advantageously has the dynamic properties of a dual-mass flywheel, in particular the desired properties of vibration isolation. In the coupled-in state of the clutch, i.e. only when the internal combustion engine is coupled into the drive train, the drive arrangement according to the invention ensures, on the one hand, a mechanical deep-pass filtering of speed fluctuations of the internal combustion engine and, on the other hand, the mechanical coupling of the internal combustion engine and electric engine for transmitting torques, produced by the internal combustion engine and electrically, to the drive train shaft. This advantageously results in a smaller space requirement in the axial direction, i.e. in the direction of a rotational axis of the drive train shaft. This is advantageous, in particular in so-called front transverse arrangements of internal combustion engines, in hybrid vehicles.

In contrast to the known methods for compensating for torsional vibrations of the drive train shaft, induced by speed fluctuations of the internal combustion engine, by the electric engine itself, the drive arrangement according to the invention ensures that a reduction of undesirable torsional vibrations of the drive train shaft by a corresponding counter moment of the electric engine requires less energy, as the vibration isolation is additionally carried out by the functionality of the dual-mass flywheel, which may also be denoted as passive vibration isolation.

Thus a reduction in undesirable torsional vibrations in the drive train of a hybrid vehicle may be implemented in a manner which is as complete and energy-saving as possible.

Also, the solution according to the invention advantageously contributes to the reduction of the total mass and total inertia of the entire drive train.

In a further embodiment, the clutch is designed as a wet or dry multi-plate clutch. A wet multi-plate clutch advantageously results in the clutch being cooled and thus may have improved operating properties and an extended service life. Also, wet multi-plate clutches in contrast to dry multi-plate clutches may be more easily controlled. With a dry multi-plate clutch, advantageously a simplified design of the clutch and weight advantages result, as fluid does not have to be supplied for lubricating the clutch and/or for cooling the clutch.

In a further embodiment, the element for torsional vibration isolation is configured as a spring or set of springs. In particular, the element for torsional vibration isolation may be configured as a so-called bow spring, wherein said bow spring has a predetermined rotational or torsional rigidity. Also, the element for torsional vibration isolation may be configured as so-called segment springs, which for example are arranged in sliding shoes on the outer periphery of the clutch part on the drive train shaft side and/or the drive train shaft. Also, the element for torsional vibration isolation may be designed as a compression spring in a lever mechanism which uses gear stages and the contour of the outer periphery of the clutch part on the drive train side and/or the drive train shaft.

The use of a bow spring as the element for torsional vibration isolation advantageously results in improved dynamic properties of the dual-mass flywheel, in particular with regard to an adjustment of a resonant frequency of the dual-mass flywheel. If the element for torsional vibration isolation is configured as a bow spring, said element advantageously may have a predetermined radius relative to a central point of the bow spring. This central point may, for example, be located on a central rotational axis of the crankshaft and/or the drive train shaft. In this case, care has to be taken that the radii of bow springs or even the further embodiments of the element cited above for torsional vibration isolation, which are components of a dual-mass flywheel, due to the desired “flexible” torsional rigidity preferably have a larger radius than elements for torsional damping (segment springs generally configured as short, straight compression springs) which are integrated in conventional clutches.

In a further embodiment, permanent magnets with alternating polarity are arranged on the circumference of the drive train shaft. The electric engine is thus in this case a permanently excited synchronous machine. Here, a rotor of the electric engine may be configured such that the desired properties of the electric engine (for example the desired torque) are produced. In this case, the rotor generally has a high rotational inertia. By the arrangement of a mass ring with predetermined properties, in this case additional dynamic properties of the drive arrangement, in particular a weight of the secondary mass, may be set, so that desired vibration isolation results. Also, by selecting specific permanent magnets and/or the arrangement thereof on the circumference in this case a weight of the secondary mass and/or a moment of inertia of the secondary mass may be set. By the selection and/or arrangements of the permanent magnets, therefore, dynamic properties of the dual-mass flywheel integrated in the clutch may be influenced or set.

In a further embodiment, the clutch part on the crankshaft side, the clutch, the clutch part on the drive train shaft side, the element for torsional vibration isolation and the rotor are arranged at least partially inside a stator of the electric engine. In this case, the electric engine is configured as a so-called inner rotor. The arrangement of the aforementioned components inside the stator advantageously results in a compact construction of the drive arrangement according to the invention which has the dynamic properties of a dual-mass flywheel for passive vibration isolation.

In a further embodiment, the electric engine is able to be activated such that a torque produced by the electric engine at least partially reduces torsional vibrations on the drive train shaft. The electric engine performs here a so-called active damping of undesirable torsional vibrations of the drive train shaft. The drive arrangement which has the dynamic properties of a dual-mass flywheel in this case ensures so-called passive vibration isolation from undesirable torsional vibrations of the drive train shaft, which are induced by speed fluctuations of the internal combustion engine. The combination of the active vibration damping and passive vibration isolation advantageously produces an improved reduction in undesirable torsional vibrations, wherein the active compensation due to the passive isolation requires less electrical energy than purely active damping by the electric engine.

In contrast to the known torsional dampers and dual-mass flywheels, the drive arrangement according to the invention does not have a damping element which is deliberately incorporated and exclusively or principally serves for vibration damping, for example frictional elements which convert vibrational energy exclusively into heat and thus reduce the vibration amplitude at and/or close to the resonant frequency. In the active vibrational damping according to the invention, in contrast to vibrational damping, “vibration peaks” are stored in an electrical energy storage device, and “vibration troughs” originating therefrom are compensated. This process is subject to losses; the amount of energy converted into heat is less than in known passive damping devices. To this end, the vibration isolation is all the greater, the lower the damping between the two flyweight masses.

In this case, undesirable torsional vibrations of the drive train shaft may be detected, for example, by sensors and signal processing of the measurement signals produced by these sensors. For example, it is conceivable to detect a rotational speed of the crankshaft of the internal combustion engine by means of a rotational speed sensor. Furthermore, a rotational speed of the drive train shaft may also be detected by means of a further rotational speed sensor.

In this case, an undesirable torsional vibration of the drive train vibration may be determined depending on a rotational speed of the drive train shaft. To this end, for example frequency contents of the rotational speed of the drive train shaft may be determined, for example by a frequency analysis, for example a Fourier transformation. In this case, undesirable torsional vibrations may be detected, if a proportion of output at specific frequencies is greater than a permitted proportional output. Naturally, in this case the proportion of output within the range produced by the desired rotational speed has to be taken into account.

Advantageously, a so-called rotor position sensor of the electric engine may be used for detecting the rotational speed of the drive train shaft. The rotor position sensor is generally present as it is necessary for controlling the electric engine. Thus, advantageously without additional components for detecting the rotational speed of the drive train shaft, the rotational speed thereof may be detected and undesirable torsional vibrations may be detected.

Undesirable torsional vibration of the drive train shaft may additionally be determined according to a rotational speed of the crankshaft.

In a further embodiment, the electric engine may be activated so that an angle of torsion between the clutch part on the drive train shaft side and the drive train shaft does not exceed a predetermined maximum angle of torsion. The predetermined maximum angle of torsion may in this case correspond to the above-mentioned limit angle of rotation or may be smaller than this limit angle of rotation by a predetermined amount (safety margin).

If a “flexible” torsionally flexible connection of the primary and secondary flywheel mass is selected, in particular with large torque engines and/or unsteady processes (for example tip-in process, tip-out process, shifting processes) this may lead to large angles of torsion, which could also lead to destruction of the element for torsional vibration isolation, for example a bow spring.

To avoid such a large angle of torsion, an angle of rotation, for example of the crankshaft, and an angle of rotation of the drive train shaft may be detected, wherein a difference between said angles of rotation corresponds to the angle of torsion. If the angle of torsion exceeds the maximum predetermined angle of torsion, the electric engine may be controlled so that the rotor, i.e. the drive train shaft, is rotated so that the angle of torsion remains constant or is reduced.

In a further embodiment, the drive train shaft is connected to a starting element. In this case, the drive arrangement according to the invention may comprise the starting element. The starting element may, for example, be configured as a double clutch. To this end, a drive arrangement configured according to the previous explanations may be arranged as a so-called “hybrid plate” between a conventional internal combustion engine and a double clutch transmission. In contrast to the above-mentioned U.S. Pat. No. 5,755,302 and DE 43 23 601 A1, advantageously the possibility exists with such a double clutch transmission of shifting without traction force interruption.

Furthermore, the connection to a starting element offers the advantage that when starting up the internal combustion engine said element may briefly slip during the journey. The rotational speed of the electric engine may be increased so that the stored “excess” energy when coupling-in the internal combustion engine may be supplied thereto by means of the clutch, without this being noticeable in the drive train. As a result, it is advantageous that starting the internal combustion engine does not lead to a perceptible drop in the vehicle speed.

A starting element may also be required when the electric engine is not powerful enough, in order to provide a drive when the vehicle drives off. The internal combustion engine would then be brought to a standstill and then have to be started up before setting off (automatic start-stop). The drive arrangement according to the invention could, for example, be arranged between a conventional internal combustion engine and a conventional manual transmission (which contains the starting element generally in the form of a foot-actuated dry single-plate clutch).

Electric engines with permanent magnets have, similar to internal combustion engines, the disadvantageous feature that they may not be driven without moment loss. Functions which are denoted as “coasting” or “freewheeling”, therefore, provide that the power engines are separated from the drive train, when no drive moment is required. By the opening of a starting element the cited functions may also be implemented for the arrangement according to the invention.

Also proposed is a method for operating an electric engine in a hybrid vehicle, wherein the hybrid vehicle comprises at least one internal combustion engine and at least the electric engine. In a drive arrangement of the hybrid vehicle, at least one clutch part on the crankshaft side is rigidly connected to a crankshaft of the internal combustion engine. The clutch part on the crankshaft side is able to be coupled to at least one clutch part on the drive train shaft side via a clutch. Furthermore, the clutch part on the drive train shaft side is mechanically connected to a drive train shaft via at least one element for torsional vibration isolation, wherein the drive train shaft is configured at least partially as a rotor of the electric engine. Furthermore, torsional vibrations, in particular undesirable torsional vibrations, on the drive train shaft are detected, wherein the electric engine is controlled such that a torque produced by the electric engine at least partially reduces torsional vibrations on the drive train shaft.

According to the invention, the clutch part on the crankshaft side, the clutch and the clutch part on the drive train shaft side form at least one part of a primary mass of a dual-mass flywheel. Furthermore, the drive train shaft, i.e. also the rotor, forms at least a part of the secondary mass of the dual-mass flywheel, wherein the primary mass and/or the secondary mass and/or the properties of the element for torsional vibration isolation are selected so that a resonant frequency of the dual-mass flywheel is below a predetermined rotational frequency of the internal combustion engine. In this case, the method for operating the electric engine is only able to be used when the internal combustion engine is coupled into the drive train, i.e. the clutch according to the invention is closed. In this case, therefore, the clutch part on the crankshaft side is coupled via the clutch to the clutch part on the drive train shaft side.

In a further embodiment, the electric engine is controlled so that an angle of torsion between the clutch part on the drive train shaft side and the drive train shaft does not exceed a predetermined maximum angle of torsion.

Other features which are considered as characteristic for the invention are set forth in the appended claims.

Each of the various patents and patent application documents mentioned above provides additional background detail with regard to the invention and accordingly, they are herewith incorporated by reference in their entirety.

Although the invention is illustrated and described herein as embodied in a drive arrangement for a hybrid vehicle and method for operating an electric engine in a hybrid vehicle, it is nevertheless not intended to be to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE shows a schematic sectional view of a drive arrangement according to the invention.

### DETAILED DESCRIPTION OF THE INVENTION

Referring now to the sole FIGURE of the drawing in detail, there is shown a schematic sectional view of a drive arrangement 1. Here, a clutch part 3 on the crankshaft side (i.e., a crankshaft-side clutch part 3) is flanged to a crankshaft 2. A periphery of the clutch part 3 carries plates 4 on the crankshaft side. The clutch part 3 on the crankshaft side, therefore, may also be denoted as a so-called internal plate carrier. A clutch part 5 on the drive train shaft side (i.e., a drive train shaft-side clutch part 5) has plates 6 on an inner periphery. The clutch part 5 on the drive train shaft side may, therefore, also be denoted as the external plate carrier. The plates 4 on the crankshaft side are in this case movable relative to the clutch part 3 on the crankshaft side, axially in the direction of a central longitudinal axis (central rotational axis of the crankshaft 2). Also the plates 6 on the drive train shaft side are axially movable relative to the clutch part 5 on the drive train shaft side. An axial movement of the plates 4, 6 in this case is by non-illustrated stops or locking rings. In this case, the plates 4 on the crankshaft side are able to be brought into mechanical frictional connections with the plates 6 on the drive train shaft side, if an element 7 for force transmission is coupled-in (movement in the direction of the left in the image), whereby the plates 6 are pressed against the plates 4. To this end, for example a hydraulic fluid may be supplied by a rotary feedthrough into a cylindrical working piston which is arranged in the clutch part 5 on the drive train shaft side, wherein the working piston is mechanically connected to the element 7 for force transmission. To this end, a drive train shaft 9 may be configured as a hollow shaft wherein fluid may be supplied through the hollow shaft and through a bore, not shown, in the drive train shaft 9 to the cylindrical working piston. Furthermore, to this end sealing elements may also be arranged between the drive train shaft 9 and the element 7 for force transmission as well as the clutch part 5 on the drive train shaft side. For example, wave-shaped springs, not shown, which are arranged, for example, between the plates 4, 6 or further springs, also not shown i.e. passive elements, serve for the disengagement. If the element for force transmission 7 is disengaged by means of the springs (movement in the direction of the right in the image) the plates 6 on the drive train shaft side are relieved of pressure and no longer press against the plates 4 on the crankshaft side. The clutch part 5 on the crankshaft side is connected fixedly in terms of rotation to the drive train shaft 9 via a bow spring 8 which represents the element according to the invention for torsional vibration isolation.

The drive train shaft 9 in this case serves as a rotor of an electric engine. In this case permanent magnets 10 are arranged on the outer circumference of the drive train shaft 9. Different shapes are available for the permanent magnets 10. The permanent magnets, as shown, may be positioned on the drive train shaft 9. Alternatively, the permanent magnets 10 may be integrated in (i.e., let into) the drive train shaft 9 or alternatively buried in the drive train shaft 9. Furthermore, it is shown that a part of the crankshaft 2, the clutch part 3 on the crankshaft side, the clutch produced by plates 4 on the crankshaft side and plates 6 on the drive train shaft side, the element 7 for force transmission, the clutch part 5 on the drive train shaft side, the bow spring 8 and a part of the drive train shaft 9 are arranged inside a stator 11 of the electric engine. The crankshaft 2 is in this case flanged onto an internal combustion engine (ICE) 12. The engine 12 and its connection to the shaft 2 are illustrated in a most highly diagrammatic fashion. The drive train shaft 9 may in this case be flanged to downstream elements of the drive train, for example a starting element.

1. A drive arrangement for a hybrid vehicle having an internal combustion engine and an electric engine, comprising:
at least one crankshaft-side clutch part rigidly connected to a crankshaft of the internal combustion engine;
a drive train shaft configured at least partially as a rotor of the electric engine;
a drive train-side clutch part and a clutch for coupling said drive train-side clutch part to said crankshaft-side clutch part;
said drive train-side clutch part being mechanically connected to said drive train shaft via at least one element for torsional vibration isolation;
said crankshaft-side clutch part, said clutch, and said drive train-side clutch part forming at least one part of a primary mass of a dual-mass flywheel, and said drive train shaft forming at least one part of a secondary mass of the dual-mass flywheel; and
wherein one or more of said primary mass, said secondary mass, or properties of said element for torsional vibration isolation are configured to render a resonant frequency of the dual-mass flywheel to lie below a predetermined rotational frequency of the internal combustion engine.

2. The drive arrangement according to claim 1, wherein said clutch is a wet multi-plate clutch.

3. The drive arrangement according to claim 1, wherein said clutch is a dry multi-plate clutch.

4. The drive arrangement according to claim 1, wherein said element for torsional vibration isolation is a spring or a set of springs.

5. The drive arrangement according to claim 1, which comprises permanent magnets with alternating polarity disposed on a circumference of said drive train shaft.

6. The drive arrangement according to claim 1, wherein said crankshaft-side clutch part, said clutch, said drive train-side clutch part, said element for torsional vibration isolation, and said drive train shaft are arranged at least partially inside a stator of the electric engine.

7. The drive arrangement according to claim 1, wherein the electric engine is enabled for activation to reduce torsional vibrations on said drive train shaft by way of a torque produced by the electric engine.

8. The drive arrangement according to claim 1, wherein the electric engine is activatable so that an angle of torsion between said drive train-side clutch part and said drive train shaft does not exceed a predetermined maximum angle of torsion.

9. The drive arrangement according to claim 1, wherein said drive train shaft is connected to a starting element.

10. A method of operating an electric engine in a hybrid vehicle, the hybrid vehicle having at least one internal combustion engine and at least one electric engine, and the hybrid vehicle further having:
a drive arrangement with at least one crankshaft-side clutch part rigidly connected to a crankshaft of the internal combustion engine, wherein:
the crankshaft-side clutch part is configured for coupling to at least one drive train shaft-side clutch part via a clutch;
the drive train shaft-side clutch part is mechanically connected to a drive train shaft via at least one element for torsional vibration isolation;
the drive train shaft is configured at least partially as a rotor of the electric engine;
the crankshaft-sdie clutch part, the clutch, and the drive train shaft-side clutch part form at least one part of a primary mass of a dual-mass flywheel;
the drive train shaft forms at least one part of a secondary mass of the dual-mass flywhee; and
the primary mass and/or the secondary mass and/or the properties of the element for torsional vibration isolation are selected so that a resonant frequency of the dual-mass flywheel lies below a predetermined rotational frequency of the internal combustion engine
the method which comprises:
detecting torsional vibrations on the drive train shaft; and
driving the electric engine such that a torque produced thereby reduces torsional vibrations on the drive train shaft.

11. The method according to claim 10, which comprises controlling the electric engine such that an angle of torsion between the drive train shaft-side clutch part and the drive train shaft does not exceed a predetermined maximum angle of torsion.
